(19) United States
(12) Patent Application Publication
(10) Pub. No.: US 2007/0121427 A1
(43) Pub. Date: May 31, 2007

(54) Media playing device and method

(75) Inventors: Chaucer Chiu, Taipei (TW); Jerry Xu, Taipei (TW); Mingming Li, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/394,842

(22) Filed: Mar. 30, 2006

(30) Foreign Application Priority Data
Nov. 28, 2005 (TW) 94141674

(51) Int. Cl. H04B 1/20

(52) U.S. Cl. 369/2

(57) ABSTRACT

A media playing device and a media playing method are proposed. An interface module of the media playing device is coupled with an external media device and information handshaking is established therebetween such that media contents stored in the external media device can be identified by an identifying module of the media playing device. A user interface is created by a user interface module of the media playing device, which allows a user to input an operating instruction. An information processing module of the media playing device processes media content related information according to the operating instruction inputted by the user. In addition, a charging interface of the media playing device is coupled with a charging terminal of the external media device such that a charging module of the media playing device can charge the external media device when power left in the external media device is not enough.

### BACKGROUND OF THE INVENTION

1. Field of the Invention

The present invention relates to an information processing technology, and more particularly to a media playing device and method.

2. Description of Related Art

Currently, home movie electronic devices are becoming more and more popular, such as digital versatile discs (DVDs), digital video recorders (DVRs), enhanced versatile discs (EVDs) and digital media adapters (DMAs). Generally, those movie devices need to be electrically connected with a device having a media playing function such as a traditional CRT (Cathode Ray Tube) television, a LCD (Liquid Crystal Display) or a plasma television or monitor.

Furthermore, portable electronic devices such as mobile phones, digital cameras are being provided with much more media information processing functions. For example, a mobile phone can be provided with digital audio and video playing functions such as music and animation playing functions, digital image capturing function, email receiving and sending function and personal data managing function. Although these portable electronic devices are provided with display units, to meet the requirement of much smaller, thinner, lighter and shorter portable electronic devices, theses display units must be made much smaller in size. Usually, the display unit of a normal portable electronic device can not be bigger than 2.5-3 inches.

As a result, it is often necessary to establish wired or wireless electrical connection between a portable electronic device and a media playing device of large size so as to obtain a better movie effect. However, such a connection only implements unidirection transferring, that is, the media playing device can only play the media contents of the portable electronic device while the media content captured or received by the media playing device can not be transferred to the portable electronic device. In addition, while a media playing device is playing the media contents of a portable electronic device, it may happen that the portable electronic device runs out of power. In this circumstance, the user has to couple the portable electronic device with a charging unit such that the portable electronic device can be charged, thereby bring inconvenience to users and affecting the playing process.

Accordingly, there is a need to develop a media playing device which can establish a bidirectional connection with a portable electronic device for information transferring and processing and further can charge the portable electronic device.

### SUMMARY OF THE INVENTION

According to the above defects, an objective of the present invention is to provide a media playing device and method which can establish the bidirectional connection between a media playing device and a portable media device for information transferring and processing.

Another objective of the present invention is to provide a media playing device and method through which, the media playing device can charge the portable electronic device.

To achieve the above and other objectives, the media playing device of the present invention comprises an interface module for being coupled with an external media device and establishing information handshaking with the external media device; an identifying module for identifying media contents stored in the external media device through the established information handshaking between the interface module and the external media device; a user interface module for creating a user interface according to the media contents identified by the identifying module; and an information processing module for processing media content related information according to an instruction inputted through the user interface by a user. The term “media” described herein and hereinafter may refer to “multimedia”.

In one embodiment, the information processing module comprises a converting module for converting a media file into different formats according to a data converting instruction of the user.

In another embodiment, the media playing device of the present invention further comprises: a charging interface for being coupled with a charging terminal of the external media device; and a charging module for detecting an amount of power left in a battery of the external media device, and charging the battery of the external media device when the power left in the battery is less than a predefined level.

The media playing method of the present invention comprises the steps of: coupling a media playing device with an external media device and establishing information handshaking therebetween; identifying media contents stored in the external media device through the information established handshaking; creating a user interface according to the media contents; and processing media content related information according to an instruction inputted through the user interface by a user.

Therein, the step of processing the media content related information further comprises converting a media file into different formats according to a data converting instruction of the user.

In another embodiment, the media playing method further comprises coupling the media playing device with a charging terminal of the external media device; and detecting an amount of power left in a battery of the external media device and charging the battery of the external media device when the power left in the battery is less than a predefined level.

Compared with the prior art, the media playing device of the present invention can establish bidirectional connection with a plurality of different kinds of external media devices for processing information related to media contents of the external media devices, and meanwhile, the media playing device can charge the external media devices.

### BRIEF DESCRIPTION OF DRAWINGS

FIG. 1 is a functional block diagram of a media playing device of the present invention;

FIG. 2 is a diagram showing the information processing steps of a media playing method of the present invention; and

FIG. 3 is a diagram showing the steps of charging an external media device according to the media playing method of the present invention.

### DETAILED DESCRIPTION OF PREFERRED EMBODIMENTS

Hereunder, embodiments of the present invention will be described in full detail with reference to the accompanying drawings.

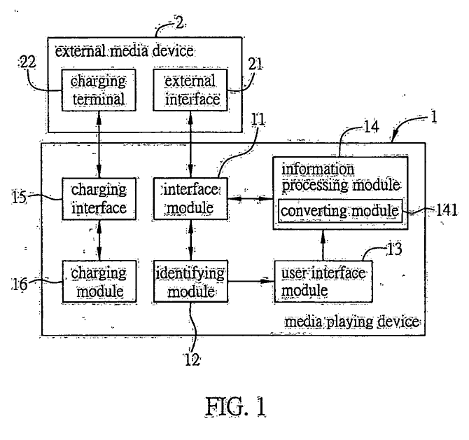

Referring to FIG. 1, a functional block diagram of a media playing device 1 is shown. The media playing device 1 comprises an interface module 11, an identifying module 12, a user interface module 13, an information processing module 14, a charging interface 15 and a charging module 16. In the present embodiment, the media playing device 1 can be a cathode ray tube display, a liquid crystal display or a plasma display.

The interface module 11 is coupled with an external media device 2 for establishing handshaking with the external media device 2. In the present embodiment, the external media device 2 is a portable media device such as a mobile phone, a digital camera or a MP3 media player, which has functions of playing digital audio such as music or digital video such as animation, capturing digital images, receiving and sending emails, or managing personal data. It should be noted that the interface module 11 is compatible with the external interface 21 of the external media device 2. For example, both the interface module 11 and the external interface 21 are USB compatible such that once the external media device 2 is coupled with the interface module 11 through the external interface 21, handshaking is established therebetween.

The identifying module 12 is used for identifying media contents stored in the external media device 2. In the present embodiment, when the handshaking is established between the interface module 11 and the external media device 2 as mentioned above, the identifying module 12 identifies the media contents stored in the external media device 2 and meanwhile extracts metadata at least comprising file names and file formats from the media contents. The media contents can be a plurality of audio files such as MP3, WMA files, image files such as JPG, BMP files, and movie files such as AVI, MP4 files.

The user interface module 13 is used to create a user interface. In the present embodiment, when the identifying module 12 identifies the media contents of the external media device 2 and extracts metadata from the media contents, the metadata is transferred to the user interface module 13 such that the user interface module 13 can create a user interface according to the metadata. For example, if the metadata represents a series of audio files, the user interface module 13 creates a user interface through which users can operate the audio files. The user interface can provide such functions as file selecting, play/pause, fast-forward/fast-backward, stop, data converting and data transferring such that a user can select one of these functions through the user interface.

The information processing module 14 is used for processing the media content related information according to the instruction inputted through the user interface by a user. In the present embodiment, when the user interface module 13 has created a user interface for audio file operation and received an instruction inputted through the user interface by a user, the information processing module 14 performs such functions as file selecting, play/pause, fast-forward/fast-backward, stop, data converting or data transferring corresponding to the instruction. Alternatively, the instruction can be inputted through a remote controller (not shown) of the media playing device 1.

In the present embodiment, the information processing module 14 further comprises a converting module 141 for converting a media file into different formats according to a data converting instruction of the user. For example, the information processing module 14 can convert the playing media file into a format that can be identified by the external media device 2, or reversely, convert the media file stored in the external media device 2 into a format that can be played by the media playing device 1 according to the data converting instruction of the user.

Further, media contents can be transferred between the media playing device 1 and the external media device 2 according to a media content transferring instruction.

The charging interface 15 is coupled with the charging terminal 22 of the external media device 2. In the present embodiment, the charging interface 15 and the charging terminal 22 have compatible interfaces.

The charging module 16 is used to detect the amount of the power left in the battery of the external media device 2, and charge the battery of the external media device 2 when the power left in the battery is less than a predefined value. In addition, a discharging process can be performed first before performing the charging process.

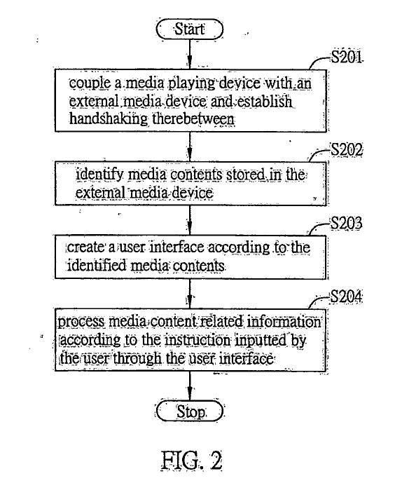

Referring to FIG. 2, the steps of a media playing method according to the present invention is shown. First, at step S201, the media playing device is coupled with an external media device and handshaking is established therebetween.

At step S202, the media playing device identifies media contents stored in the external media device through the established handshaking.

At step S203, a user interface is created by the media playing device according to the identified media contents.

At step S204, the media content related information is processed according to the instruction inputted through the user interface by a user.

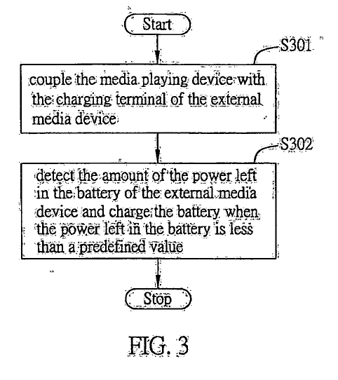

FIG. 3 shows the charging steps of the media playing method. First, at step S301, the media playing device is coupled with the charging terminal of the external media device.

At step S302, the media playing device detects the amount of the power left in the battery of the external media device, and charges the battery of the external media device in the event the power left in the battery is less than a predefined value.

According to the media playing device and method of the present invention, a single media playing device can establish bidirectional and electrical connection with a plurality of different kinds of external media devices and process media content related information of the plurality of external media devices. Further, the media playing device can provide charging function for the external media devices.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A media playing device, comprising:
an interface module for being coupled with an external media device and establishing information handshaking with the external media device;
an identifying module for identifying media contents stored in the external media device through the established information handshaking between the interface module and the external media device;
a user interface module for creating a user interface according to the media contents identified by the identifying module; and
an information processing module for processing media content related information according to an instruction inputted through the user interface by a user.

2. The media playing device of claim 1, wherein the identifying module is further for extracting metadata comprising file names and file formats from the identified media contents.

3. The media playing device of claim 1, wherein the information processing module comprises a converting module for converting a media file into different formats according to a data converting instruction of the user.

4. The media playing device of claim 1, further comprising:
a charging interface for being coupled with a charging terminal of the external media device; and
a charging module for detecting an amount of power left in a battery of the external media device, and charging the battery of the external media device when the power left in the battery is less than a predefined level.

5. The media playing device of claim 1, wherein the external media device is a portable media device having one or more functions selected from the group consisting of digital audio playing, digital video playing, digital image capturing, email receiving and sending, and personal data managing.

6. A media playing method applicable to a media playing device, comprising the steps of:
coupling the media playing device with an external media device and establishing information handshaking therebetween;
identifying media contents stored in the external media device through the established information handshaking;
creating a user interface according to the media contents; and
processing media content related information according to an instruction inputted through the user interface by a user.

7. The media playing method of claim 6, wherein the step of identifying the media contents further comprises extracting metadata comprising file names and file formats from the identified media contents.

8. The media playing method of claim 6, wherein the step of processing the media content related information according to the inputted instruction further comprises converting a media file into different formats according to a data converting instruction of the user.

9. The media playing method of claim 6, further comprising the steps of:
coupling the media playing device with a charging terminal of the external media device; and
detecting an amount of power left in a battery of the external media device, and
charging the battery of the external media device when the power left in the battery is less than a predefined level.

10. The media playing method of claim 6, wherein the external media device is a portable media device having one or more functions selected from the group consisting of digital audio playing, digital video playing, digital image capturing, email receiving and sending, and personal data managing.
